(19) United States
(12) Patent Application Publication
(10) Pub. No.: US 2007/0225540 A1
(43) Pub. Date: Sep. 27, 2007

(54) Method and apparatus for mitigating mercury vapor emissions during transportation of mercuty containing universal waste

(76) Inventor: Laurence C. Kelly, Park Ridge, IL (US)

Correspondence Address: JOHN W. HARBST, 1180 LITCHFIELD LANE, BARTLETT, IL, 60103, US

(21) Appl. No.: 11/525,449

(22) Filed: Sep. 22, 2006

Related U.S. Application Data
(60) Provisional application No. 60/786,150, filed on Mar. 27, 2006.

(51) Int. Cl. B09B 5/00

(52) U.S. Cl. 588/249

(57) ABSTRACT

An apparatus for mitigating mercury vapor emissions during transportation of mercury containing universal waste between locations. The apparatus includes a container having a bottom, sidewall structure extending from the closed bottom, and an opening for allowing the mercury containing universal waste to be inserted into the container. The opening in the container is releasably closed by a cover when the apparatus is transported between locations. Activated carbon media is arranged in the container after the container is closed The activated carbon media has an affinity for mercury vapors escaping from the mercury containing universal waste during transportation of the apparatus between locations and thereby mitigates mercury vapors escaping from the apparatus. A method for mitigating mercury vapor emissions during transportation of mercury containing universal waste between locations is also disclosed.

### RELATED APPLICATION

This patent application claims the benefit of provisional patent application Ser. No. 60/786,150; filed Mar. 27, 2006.

### FIELD OF THE INVENTION

The present invention generally relates to mercury containing universal waste and, more specifically, to a method and apparatus for mitigating mercury vapor emissions during transportation of mercury containing universal waste between locations.

### BACKGROUND OF THE INVENTION

Fluorescent lamps containing mercury are widely used in schools, factories, office buildings, shopping centers, as well as other smaller uses and require regular replacement. Spent mercury containing fluorescent and high intensity discharge (HID) lamps, ballasts, batteries, thermostats, thermometers, and related spent mercury containing devices are hereinafter commonly referred to as “mercury containing universal waste.” Disposal and/or recycling of such mercury containing universal waste has proven both costly and problematical.

Recycling of mercury containing universal waste has been regulated by both the United States Environmental Protection Agency and on a state by state basis because such spent product produces significant source of mercury vapors. 40 CFR Part 273 is one federal regulation relating to the recycling of such mercury containing universal waste. Additionally, OSHA has regulated uncontrolled emissions of mercury vapor in the workplace (Permissible Exposure Limit (PEL) not to exceed 0.100 mg/m³) since 1992. (See 29 C.F.R. Part 1910-1000). The USEPA and OSHA have each addressed both the sudden or immediate and non-sudden (prolonged buildup over time) environmental impairments mercury exposure create in the workplace. Both now recognize the subtle but very real and very hazardous consequences of prolonged exposure to mercury vapors exceeding the above-mentioned limits which can emanate when mercury containing universal waste is not properly handled.

In spaced locations throughout the country, there are processing facilities for rendering such mercury containing universal waste innocuous. To safely transport the mercury containing universal waste from a point of generation to such processing facilities, however, has been and continues to be an ongoing health issue. Besides breaking or fracturing of such mercury containing universal waste in the workplace, accidental breakage frequently occurs during the course of handling and transportation of the potentially hazardous toxic material to such a processing facility. Notably, all fluorescent lamps, including those deemed ecologically safe, contain at least 0.25 mg/m³ of mercury. Each time 3 or 4 lamps are broken during handling or transportation, mercury emissions are created which exceed OSHA standards ten fold.

Small to mid-size generators of mercury containing universal waste frequently use a mail-in program for transporting the mercury containing universal waste to an approved processing facility. A typical mail-in program requires the generator to package the mercury containing universal waste in a container which is thereafter transported, either by a common carrier or any one of several well known package delivery services, to a permitted processing facility for recycling. Depending upon the size of the mercury containing universal waste being shipped for recycling, some such containers can hold as many as 144 mercury containing lamps. Currently, the mercury containing universal waste being shipped must be identified as “hazardous” thus causing the small to mid-size generator to incur a very expensive transportation cost. Moreover, the drivers picking up and delivering those containers having mercury containing universal waste therewithin are continuously subjected to mercury vapor exposures emanating from universal waste traveling through their systems. As such, the drivers and other employees handling such containers are subjected to very high and bio-accumulative toxic mercury vapor exposure levels far exceeding published OSHA guidelines.

Thus, there is a continuing need and desire for an economical method and apparatus for mitigating mercury vapor emissions during the transportation of mercury containing universal waste between locations.

### SUMMARY OF THE INVENTION

According to one aspect, there is provided an apparatus for mitigating mercury vapor emissions, caused as a result of breakage or fracturing of the mercury containing universal waste, during transportation of mercury containing universal waste between locations. In one form, the apparatus includes a container having a closed bottom, sidewall structure extending from the closed bottom, and an opening for allowing insertion of the mercury containing universal waste into the container. The container opening is releasably closed by a cover or lid structure when the apparatus is transported between locations. An activated carbon media is arranged in the container after the opening is closed by the cover or lid structure. The activated carbon media has an affinity for mercury vapors escaping from the mercury containing universal waste during transportation of the apparatus between locations and thereby mitigates mercury vapors escaping from the apparatus.

In one form, the container into which the mercury containing universal waste is inserted is a disposable box fabricated from relatively rigid cardboard materials. In this form, the lid structure of the container comprises a pair of flaps foldable inwardly relative to the sidewall structure when the open-top of the container is to be closed. In another form, the container has a bucket-like configuration. In this form, the lid structure includes a cover releasably attachable to an upper end of the container. In either embodiment, the lid structure is preferably sealed, as with tape or the like, to the reminder of the container after the mercury containing universal waste is inserted thereinto and prior to shipment of the apparatus from one location to another.

The activated carbon media preferably comprises a predetermined volume of activated carbon material. In one form, the activated carbon material is enclosed within a porous envelope for adsorbing mercury vapors escaping from the mercury containing universal waste.

In a preferred embodiment, the apparatus for mitigating mercury vapor emissions during transportation of the mercury containing universal waste further includes a non-porous liner within the container. The liner is configured to receive the mercury containing universal waste. To reduce the presence of mercury vapors within the apparatus during transportation, an opening in the liner through which the mercury containing universal waste is inserted, is preferably sealed as with as with tape of the like.

According to another aspect, the apparatus for mitigating mercury vapor emissions during transportation of the mercury containing universal waste between locations includes a multisided container defining an opening through which the mercury containing universal waste is inserted into the container. The multisided container includes a pair of hinged flaps for closing the opening when the container is transported between locations. An activated media is arranged within the container before the opening in the container is closed. The activated carbon media has an affinity for mercury vapors escaping from the mercury containing universal waste during transportation of the apparatus between locations and thereby mitigates mercury vapors escaping from the apparatus.

Preferably, the activated carbon media includes an activated carbon material enclosed within a porous envelope. The activated carbon material in the apparatus adsorbs mercury vapors escaping from the mercury containing universal waste. The multisided container is preferably configured as a disposable box fabricated from relatively rigid cardboard materials. In one form, a non-porous liner receives and is accommodated within the multisided container.

According to another aspect, the apparatus for mitigating mercury vapor emissions during transportation of the mercury containing universal waste between locations includes a six sided container defining a generally horizontal elongated opening extending along a top of the container and through which the mercury containing universal waste is inserted into the container. The container further includes a generally horizontal and elongated bottom with side wall structure extending upwardly from the bottom. According to this aspect, the container further includes a pair of elongated flaps for closing the opening when the container is transported between locations. A sealable non-porous liner is arranged within the container for receiving and accommodating the mercury containing universal waste inserted into the container. Moreover, an activated carbon media is arranged within the container. The activated carbon media has an affinity for mercury vapors escaping from the mercury containing universal waste during transportation of the apparatus between locations and thereby mitigates mercury vapors escaping from the apparatus.

Preferably, the activated carbon media includes a predetermined volume of activated carbon material enclosed within a porous envelope for adsorbing mercury vapors escaping from the mercury containing universal waste. In one form, the porous envelope includes a flexible, fiberglass mesh material having the predetermined volume of activated carbon material therewithin. To reduce costs, the porous envelope holding the activated carbon material is preferably reusable after the apparatus reaches the its final destination.

According to still another aspect, a method for mitigating mercury vapor emissions during transportation of mercury containing universal waste between locations is provided. The method comprises the steps of: inserting mercury containing universal waste into a container having a closed bottom, sidewall structure extending from the closed bottom, and an opening through which the mercury containing waste is inserted into the container; then, placing an activated carbon media in the container. After the mercury containing device and activated carbon media are arranged in the container, the opening of the container is closed with a cover or lid structure. The activated carbon media has an affinity for mercury vapors escaping from the mercury containing device during transportation between locations and thereby mitigates mercury vapors escaping from the container.

The method mitigating mercury vapor emissions during transportation of the mercury containing universal waste between locations can further include the further steps of: inserting the mercury containing universal waste into a non-porous liner accommodated within the container. Then, the open-top liner is sealed with the mercury containing universal waste therewithin prior to closing the container. Moreover, the cover or lid structure is preferably sealed to the container.

The activated carbon media preferably includes a predetermined volume of activated carbon materials enclosed within a porous envelope for adsorbing mercury vapors escaping from the mercury containing universal waste. In one form, the container into which the mercury containing universal waste is inserted is a disposable box fabricated from relatively rigid cardboard materials.

One feature of this invention relates to an economical apparatus for mitigating mercury vapor emissions during transportation of mercury containing universal waste between distant locations while rendering potentially high toxic mercury vapor emissions harmless by capturing such vapors at their point of generation inside the container in which the mercury containing universal waste is being shipped.

Another feature of this invention relates to an apparatus for mitigating mercury vapor emissions during transportation of mercury containing universal waste between distance locations without having to manage the mercury containing universal waste being transported as “hazardous” thus significantly reducing the transportation costs for such mercury containing universal waste.

Another feature of this invention relates to an apparatus for mitigating mercury vapor emissions during transportation of mercury containing universal waste between distant locations in an economic fashion while protecting handlers and transporters moving such mercury containing universal waste to the proper processing facilities for recycling.

Still another aspect of this invention is to provide an economical apparatus for mitigating mercury vapor emissions during transportation of mercury containing universal waste between locations while significantly reducing the toxic mercury vapor levels to which those individuals handling the apparatus are exposed.

These and other features, aims, and advantages of the present invention will become more readily apparent from the following detailed description, drawings and appended claims.

### DESCRIPTION OF THE DRAWINGS

FIG. 1 is a left top perspective view of one embodiment of an apparatus for mitigating mercury vapor emissions during transportation of mercury containing universal waste between locations embodying principals of the invention;

FIG. 2 is a fragmentary side view of the apparatus shown in FIG. 1 with some panels of one form of a container in unassembled condition relative to the remainder of the container;

FIG. 3 is an enlarged, fragmentary longitudinal sectional view of the container illustrated in FIG. 2 in partially assembled condition;

FIG. 4 is an enlarged fragmentary longitudinal sectional view schematically showing a liner inserted into the container;

FIG. 5 is a fragmentary top plan view of the liner shown in FIG. 4 in a sealed condition;

FIG. 6 is a fragmentary longitudinal sectional view of the container shown in FIG. 1;

FIG. 7 is a top plan view of one form of a packet for holding an activated carbon media;

FIG. 8 is a sectional view taken along line 8-8 of FIG. 7;

FIG. 9 is a side elevational view of another embodiment of an apparatus mitigating mercury vapor emissions during transportation of mercury containing universal waste between locations embodying principals of the present invention; and

FIG. 10 is an enlarged fragmentary view, partly in section, of an upper end of another form of container and lid structure used to mitigate mercury vapor emissions during transportation of mercury containing universal waste between locations

### DETAILED DESCRIPTION OF THE INVENTION

While the present invention is susceptible of embodiment in multiple forms, there is shown in the drawings and will hereinafter be described preferred embodiments of the invention, with the understanding the present disclosure sets forth exemplifications of the invention which are not intended to limit the invention to the specific embodiment illustrated and described.

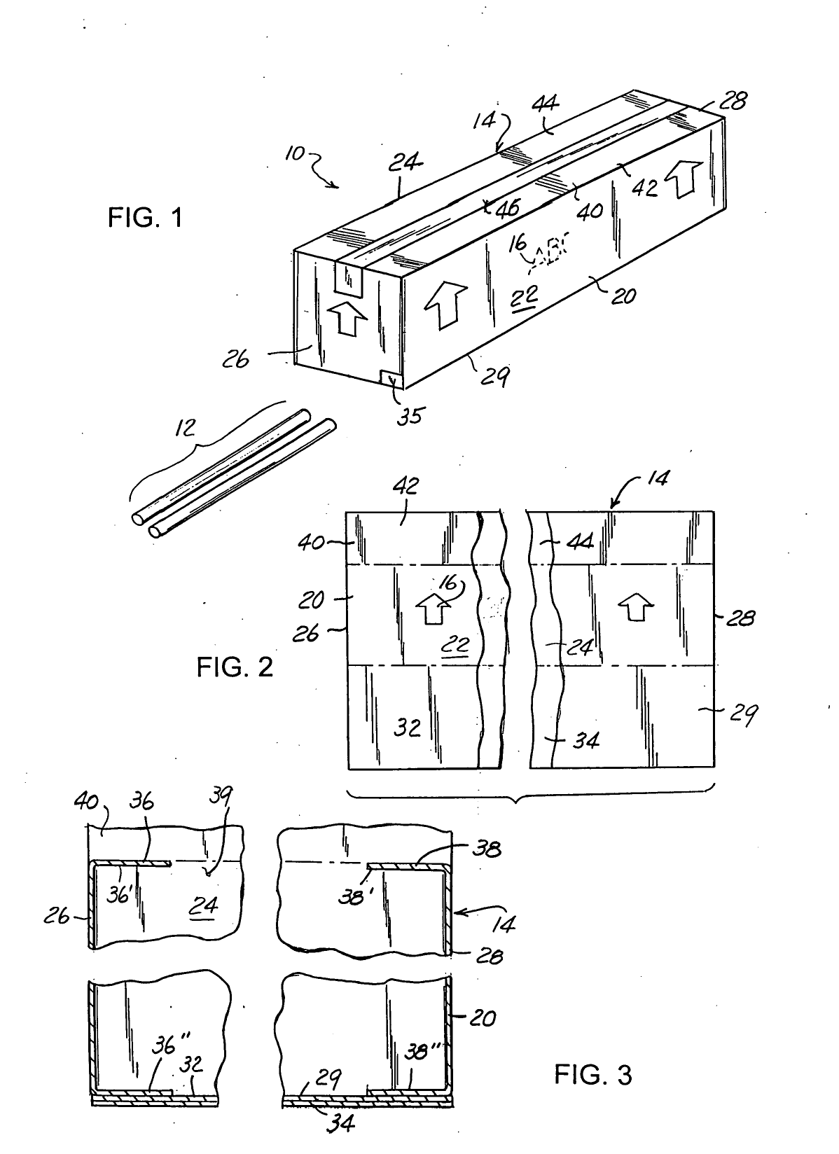

Referring now to the drawings, wherein like reference numerals indicate like parts throughout the several view, there is shown in FIG. 1 an apparatus, generally identified by reference numeral 10, for mitigating mercury vapor emissions during transport of mercury containing universal waste, generally identified by reference numeral 12 in FIG. 1, between distant locations. In FIG. 1, the mercury containing universal waste 12 is illustrated, for exemplary purposes, as being elongated mercury containing fluorescent bulbs or lamps. It should be appreciated, however, the mercury containing universal waste 12 can have other shapes, sizes and configurations other than shown for exemplary purposes.

Apparatus 10 includes a container 14 which is preferably configured depending upon the type of mercury containing universal waste being handled and transported. In one form, container 14 has a multisided configuration with suitable indicia 16 on one or more of the exterior surfaces thereof. In one form, container 14 has about a 48 inch length, about a 12 inch width, and about a 12 inch height. When so designed, container can transport about 144 elongated mercury containing fluorescent bulbs or lamps therewithin.

In the exemplary embodiment shown in FIG. 1, container 14 includes sidewall structure 20 comprising elongated front and rear, generally parallel and flat panels 22 and 24, respectively, joined to a pair of generally parallel and flat end panels 26 and 28 (FIGS. 1 and 3). As shown, the sidewall structure 20 of container 14 is arranged in upstanding relation relative to a longitudinally elongated and closed bottom 29.

As shown in FIG. 2, the bottom 29 of container 14 preferably includes two elongated and generally flat panels 32 and 34 which, in one form, are hinged along a lower edge of the front and rear panels 22 and 24, respectively. In the illustrated embodiment, each bottom panel 32, 34 has a width equal to a width of the end panels 26, 28 (FIG. 1) so as to add strength and rigidity to the container 14. An elongated adhesive tape strip 35 (FIG. 1) serves to secure the lowermost of the bottom panels 32, 34 in a closed position relative to the remainder of the container 14. It will be appreciated, however, the bottom 29 of container 14 can have configurations other than that shown without detracting or departing from the spirit and scope of the present invention.

Preferably, and as shown in FIG. 3, container 14 further includes a two pairs of end flaps 36 and 38 which fold inwardly generally at right angles relative to their respective end panel 26, 28 when container 14 is closed for transport. In the illustrated embodiment, the first pair of end flaps 36 include flaps 36′ and 36″ which, preferably, are as wide as and are hingedly connected along upper and lower edges of end panel 26. In the illustrated embodiment, the other pair of end flaps 38 include flaps 38′ and 38″ which, preferably, are as wide as and are hingedly connected along upper and lower edges of end panel 28 of container 14.

As shown in FIG. 3, container 14 defines an elongated opening 39 through which mercury containing universal waste is inserted into apparatus 10. Lid structure or cover 40 serves to releasably close the open-top 39 of the container 14 after the mercury containing universal waste is inserted into the container 14 for transport. In the embodiment shown in FIGS. 1 and 2, lid structure 40 includes a pair of longitudinally elongated flaps or panels 42 and 44 preferably hinged to fold at right angles relative to and inwardly of the front and rear panels 22 and 24, respectively. As will be appreciated, and when folded into a closed condition (FIG. 1), panels 42 and 44 combine with each other to extend across and close the open-top 39 of apparatus 10. Preferably, flaps 36′, 38′ underlie and add support to the panels 42, 44 when the container 14 is closed. Moreover, and after the panels 42, 44 are arranged to close the top 39 of the container 14, an elongated adhesive tape strip 46 extends across the exterior to maintain the lid structure 40 in closed position. Preferably, the tape strip 46 furthermore serves to seal apparatus 10.

Container 14 is preferably fabricated from relatively rigid cardboard material. As such, container 14 can be economically designed and is considered disposable. In one form, the cardboard material forming container 14 is corrugated to add to the strength of the container 14 while reducing the weight thereof.

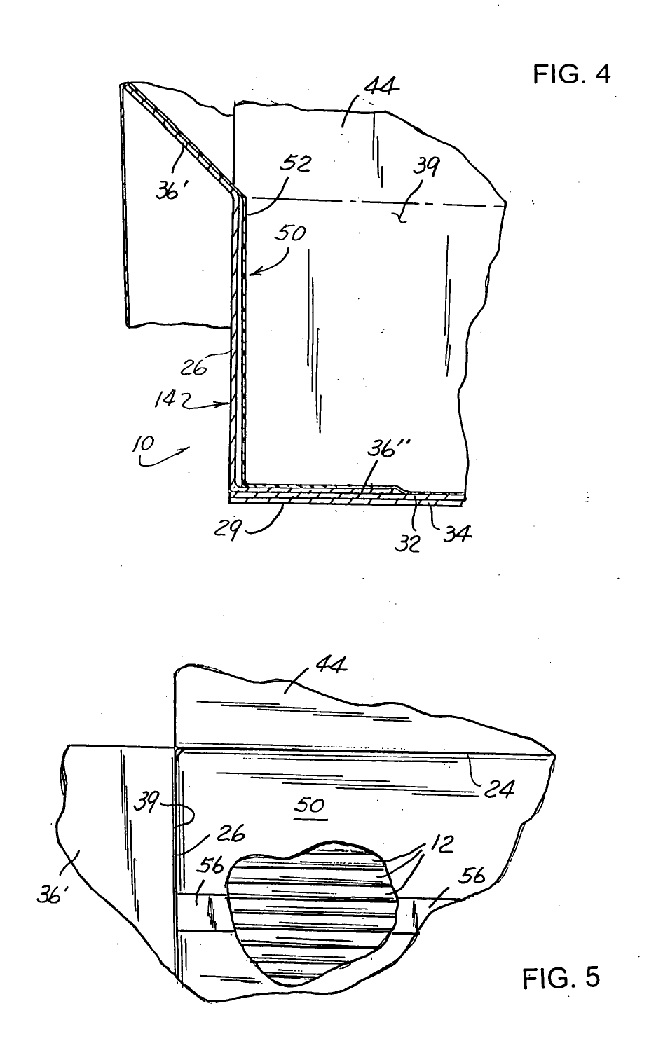

In the form shown in FIG. 4, apparatus 10 further includes a liner 50 for the container 14. Liner 50 has an open-top 52 arranged in registry with the open-top 39 of the container 14 and through which the mercury containing universal waste is inserted into the container 14. Liner 50 is preferably formed from a non-porous material such as plastic or the like. Liner 50 has a suitable thickness to inhibit inadvertent tearing of the liner material as the mercury containing universal waste is received therewithin. Preferably, liner 50 can range in thickness from about 1.5 mils to about 6 mils. In a most preferred form, liner 50 has a thickness of about 2 mils. To optimize the load carrying capacity of apparatus 10, liner 50 preferably has gussetted corners so as to allow liner 50 to better fit within the container 14.

Suffice it to say, liner 50 is sized relative to the interior of the container 14 such that after the mercury containing universal waste is received through the opening 52, sufficient liner material remains allowing the free ends of the liner 50 to be laid over each other, preferably in a multifolded fashion, to operably close the open-top 52 of the liner. Preferably, and as shown in FIG. 5, after the liner 50 is operably closed, an adhesive strip of tape-like material 56 operably seals the closed top of the liner 50 to inhibit mercury vapors from escaping therefrom.

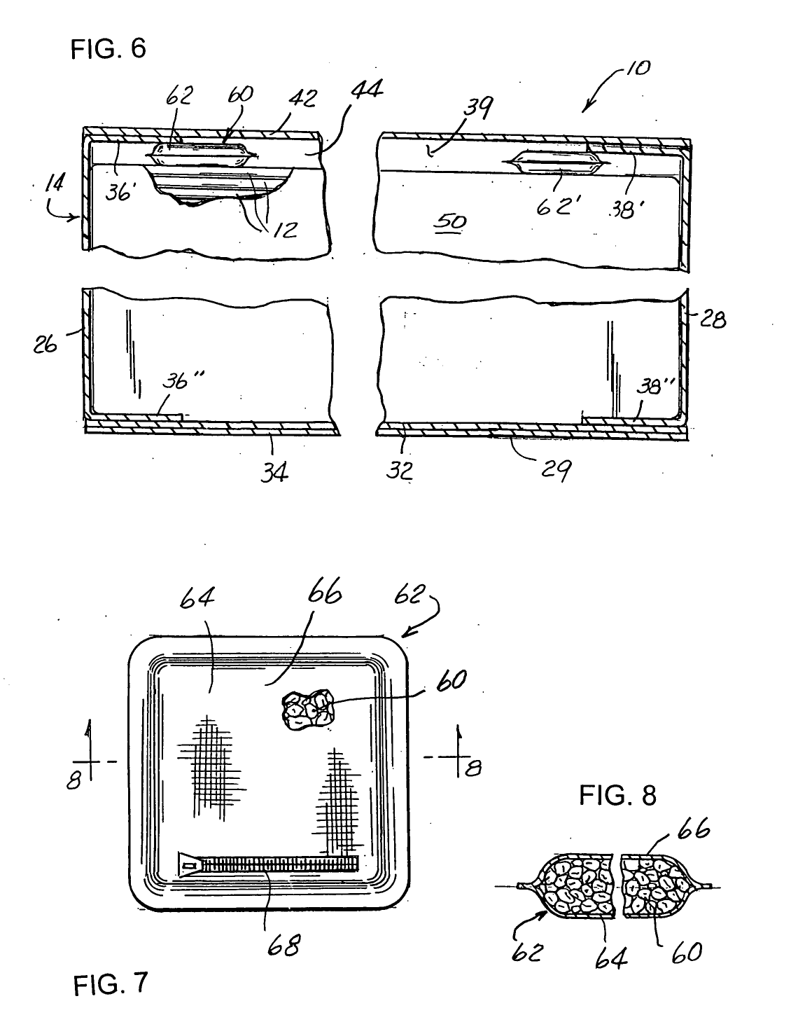

Apparatus 10 further includes a mercury vapor adsorption system for reducing mercury vapor concentrations within container 14 to a level below detectable limits. As shown in FIG. 6, apparatus 10 includes a predetermined amount activated carbon media 60 held in the container 14 after the opening 39 is closed by the lid structure 40. Preferably, the activated carbon media is arranged within the container 14 and outside of the sealed liner 50. Notably, the activated carbon media 60 has an affinity for mercury vapors escaping from the mercury containing universal waste during transportation of the apparatus 10 between locations thereby mitigating mercury vapors escaping from the apparatus 10.

As shown in FIG. 6, the activated carbon media 60 is preferably carried and maintained within a packet 62 including a predetermined amount or volume of activated carbon material of the type sold by Calgon Carbon Corporation of Pittsburgh, Pa. under Type HGR® activated carbon. As will be appreciated, apparatus 60 can include more than one packet of activated carbon material 62′ without detracting or departing from the spirt and scope of the invention.

Turning to FIGS. 7 and 8, each packet 62 includes a porous envelope 64 for holding a predetermined amount or volume of activated carbon material 60 therewithin. The predetermined amount or volume of activated carbon material in each packet 62 is treated to adsorb mercury vapors escaping from the mercury containing universal waste being transported within the container 14. In the exemplary form shown in FIG. 8, the porous envelope 64 is fabricated from a flexible and pliable fiberglass mesh material 66 which is sealed to inhibit the activated carbon material from escaping therefrom. In that form shown in FIG. 7, envelope 64 includes a resealable closure apparatus 68, i.e., a zipper, or other conventional resealable securing device so as to allow activated carbon materials to be added, replaced or exchanged.

When manufactured, mercury containing fluorescent bulbs or lamps are under negative air. Accordingly, when they break, such lamps implode rather than explode. The vacuum created when such lamps break within container 14, initially traps the escaping mercury vapors for about 30 to 40 seconds, thus, allowing the activated carbon media 66 within each packet 64 to adsorb the mercury vapors in a timely and efficient manner.

The elongated configuration of the container 14 coupled with the elongated open-top 39 design yields several unique advantages. First, the elongated configuration of the container 14 and, more specifically, the horizontally elongated and closed bottom 29 adds stability to the container 14. As such, the container 14 will be less likely to tip over and fall during staging of the mercury containing universal waste therewith. Since container 14 is less likely to tip and fall, there is less likelihood the mercury containing universal waste stored for transportation therewithin will fracture and/or break thereby further reducing the possibility of mercury vapors escaping into the ambient atmosphere. Second, the horizontally elongated configuration of the container 14 adds stability during transport of apparatus 10. Known devices for transporting mercury containing universal waste have an open end. As such, and when arranged in a lamp staging area, such known transport devices commonly attract an accumulation of trash therewithin. As will be appreciated, removing trash from a four foot long vertical container is exceptionally difficult without having to tip or otherwise invert the container. Designing the container 14 with a lower horizontally elongated profile—rather than a vertical profile—tends to not attract trash as frequently as the vertically disposed and designed containers. Additionally, the lower horizontal profile of container 14 significantly reduces, bunching, tearing and/or ripping of liner 50 as the mercury containing universal waste is loaded thereinto.

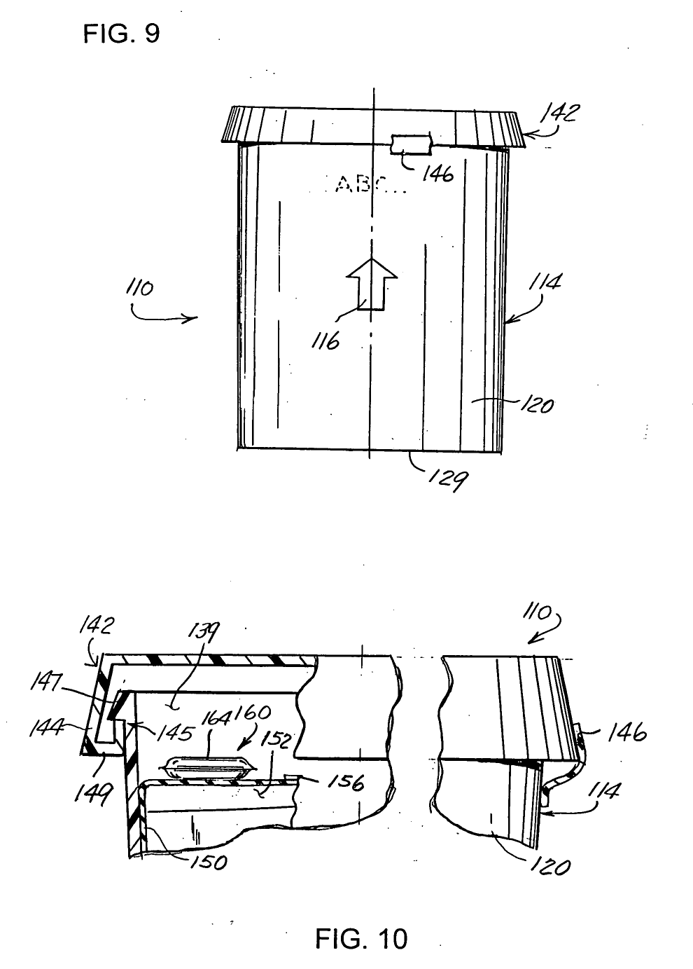

An alternative form of apparatus for mitigating mercury vapor emissions during transportation of mercury containing universal waste between locations and embodying features of the present invention is illustrated in FIGS. 9 and 10. This alternative form of apparatus for mitigating mercury vapor emissions during transportation of mercury containing universal waste is designated generally by reference numeral 110. The elements of this apparatus for mitigating mercury vapor emissions during transportation of mercury containing universal waste that are identical or functionally analogous to those components discussed above regarding apparatus 10 are designated by reference numerals identical to those used above with the exception this embodiment uses reference numerals in the 100 series.

As shown in FIG. 9, the apparatus 110 for mitigating mercury vapor emissions during transportation of mercury containing universal waste between locations includes a container 114 having a bucket-like configuration. Suitable indicia 116 can be imprinted on an exterior of the container 114. In that form shown in FIG. 9, container 114 comprises sidewall structure 120 arranged in upstanding relation relative to a closed bottom 129. In the illustrated embodiment, the closed bottom 129 is formed integral with the upstanding sidewall structure 120. In a most preferred form, container 114 is fabricated from a suitable and relatively rigid plastic material.

As shown in FIG. 10, toward an upper end, container 114 defines an open-top 139 through which the mercury containing universal waste is inserted into the container 114. After the mercury containing universal waste is inserted into the container 114, the open-top 139 of the container 114 is releasably closed by lid structure or cover 142. In the illustrated embodiment, container 114 and a depending skirt portion 144 of lid structure 142 embody cooperating instrumentalities 145. Such cooperating instrumentalities 145 can take a myriad of different designs such as cooperating thread-like configurations or the like. In the illustrated embodiment, an annular protrusion 147 is provided toward the upper end of the container 114. Such annular protrusion 147 on container 114 cooperates in a well known manner with suitable conventional structure 149 on the skirt portion 144 of the lid structure 142 to releasably secure the container 114 and lid structure 142 in operable combination.

Apparatus 110 furthermore preferably includes a liner 150 for container 114. In the form shown in FIG. 10, liner 150 has an open-top 152 through which the mercury containing universal waste to be transported is inserted into the liner 150 and container 114. As mentioned with respect to liner 50 above, liner 150 is sized such that after the mercury containing universal waste to be transported is received through the opening 152, sufficient liner material remains allowing the free ends of the liner 152 to be laid over each other, preferably in a multifolded fashion, to operably close the open-top 152 of the liner 150. Preferably, after the liner 152 is operably closed, an adhesive strip of tape-like material or a suitable twist-tie 156 operably seals the closed top of the liner 150 to inhibit mercury vapors form escaping therefrom.

Like apparatus 10, and as shown in FIG. 10, apparatus 110 includes a predetermined amount or volume of activated carbon media 160 which serves as a mercury vapor adsorption system and reduces mercury vapor concentrations within container 114 to a level below detectable limits. Like that discussed above in detail, the activated carbon media 160 is preferably in the form of at least one packet 164 containing activated carbon material. As will be appreciated, apparatus 110 can include more than one packet of activated carbon material without detracting or departing from the spirt and scope of the invention.

After the mercury containing universal waste is inserted into container 114 and cover 142 is arranged to operably close the open-top 139 of container 114, an adhesive tape strip 146 (FIG. 9) annularly extends about and between the container 114 and cover 142 to maintain the cover 142 in a closed condition. Preferably, the tape strip 46 furthermore serves to seal apparatus 110.

Regardless of the particular shape of the container used to transport the mercury containing universal waste, the activated carbon media arranged within the transport container is preferably designed to adsorb at least three times the total amount of mercury vapor emissions that could possibly be generated by the mercury containing universal waste being transported within the container. During the adsorption process, mercury is attracted to the surface of the activated carbon media where a chemical reaction converts the mercury to mercuric sulfide. The sulfide product is then retained in the pores of the activated carbon granules. Preferably, the mercury capacity of the carbon media is as high as 20% by weight.

The activated carbon media within each transport container captures mercury vapor emissions at their point of generation thereby mitigating mercury vapors from escaping from the transport apparatus of the present invention. As such, transport companies will no longer be driven to manage the mercury containing universal waste being shipped for processing as “hazardous”, thus, significantly decreasing the transportation costs thus allowing the generators of such mercury containing universal waste to pro-actively participate in affordable recycling programs while concurrently decreasing their liability issues.

In a preferred form, each packet of activated carbon material weighs less than eight (8) ounces and, thus, does not add to the transportation costs involved with the apparatus of the present invention. Moreover, each packet of activated carbon material is reusable several different times before the adsorption level of the activated carbon media is adversely affected.

From the foregoing, it will be observed that numerous modifications and variations can be made and effected without departing or detracting from the true spirit and novel concept of the present invention. Moreover, it will be appreciated, the present disclosure is intended to set forth an exemplification of the invention which is not intended to limit the invention to the specific embodiment illustrated. Rather, this disclosure is intended to cover by the appended claims all such modifications and variations as fall within the spirit and scope of the claims.

What is claimed is:

1. An apparatus for mitigating mercury vapor emissions during transportation of mercury containing universal waste between locations, said apparatus comprising:
a container having a bottom, sidewall structure extending upward from said bottom, and an opening for allowing the mercury containing universal waste to be inserted into the container, with the opening of said container being releasably closed by a cover when said apparatus is transported between locations; and
an activated carbon media arranged in said container after said container is closed by said cover, with said activated carbon media having an affinity for mercury vapors escaping from said mercury containing universal waste during transportation of said apparatus between locations and thereby mitigating mercury vapors escaping from said apparatus.

2. The apparatus according to claim 1, wherein said activated carbon media is enclosed within a porous envelope for adsorbing mercury vapors escaping from said mercury containing universal waste.

3. The apparatus according to claim 1, wherein said container is a disposable box fabricated from relatively rigid cardboard materials.

4. The apparatus according to claim 3, wherein the cover of said container comprises a pair of flaps foldable inwardly relative to said sidewall structure when the opening defined by said container is to be closed.

5. The apparatus according to claim 1, wherein said container has a bucket-like configuration, and wherein said cover releasably attaches to an upper end of said container.

6. The apparatus according to claim 1 further including a non-porous liner accommodated within said container for receiving said mercury container devices inserted into said apparatus.

7. An apparatus for mitigating mercury vapor emissions during transportation of mercury containing universal waste between locations, said apparatus comprising:
a multisided container defining an opening through which mercury containing universal waste is inserted into said container, with said multisided container including at least one hinged flap for closing said opening when said container is transported between locations; and
activated carbon media arranged within said container, with said activated carbon media having an affinity for mercury vapors escaping from said mercury containing universal waste during transportation of said apparatus between locations and thereby mitigating mercury vapors escaping from said apparatus.

8. The apparatus according to claim 7, wherein said activated carbon media is enclosed within a porous envelope for adsorbing mercury vapors escaping from said mercury containing universal waste.

9. The apparatus according to claim 7, wherein said multisided container is a disposable box fabricated from relatively rigid cardboard materials.

10. The apparatus according to claim 7 further including a non-porous liner accommodated within said multisided container for receiving said mercury container devices inserted into said apparatus.

11. An apparatus for mitigating mercury vapor emissions during transportation of mercury containing universal waste between locations, said apparatus comprising:
a six sided container defining a horizontally elongated opening extending along a top of said container and through which mercury containing universal waste is inserted into said container, said container further including a horizontally elongated and closed bottom with side structure extending upwardly from said bottom, and with said container further including a pair of elongated flaps hinged to said side structure for closing said opening when said container is transported between locations;
a sealable non-porous liner within said container for receiving and accommodating the mercury containing universal waste inserted into said container; and
an activated carbon media arranged within said container, with said activated carbon media having an affinity for mercury vapors escaping from said mercury containing universal waste during transportation of said apparatus between locations and thereby mitigating mercury vapors escaping from said apparatus.

12. The apparatus according to claim 11, wherein said activated carbon media is enclosed within a porous envelope for adsorbing mercury vapors escaping from said mercury containing universal waste.

13. The apparatus according to claim 11, wherein the porous envelope holding said carbon media includes a flexible, fiberglass mesh material having said predetermined volume of activated carbon media therewithin.

14. The apparatus according to claim 13, wherein the porous envelope holding said activated carbon media therewithin is reusable after said apparatus reaches the final destination thereof.

15. A method for mitigating mercury vapor emissions during transportation of mercury containing universal waste between locations, said method comprising the steps of:
placing mercury containing universal waste into a container having a bottom, sidewall structure extending upward from the bottom, and an opening through which said mercury containing universal waste is inserted into said container;
inserting activated carbon media into said container, with said activated carbon media having an affinity for mercury vapors escaping from said mercury containing universal waste during transportation of the container between locations and thereby mitigating mercury vapors escaping from said container; and
closing the opening in said container with a cover.

16. The method for mitigating mercury vapor emissions during transportation of mercury containing universal waste between locations according to claim 15, said method comprising the further step of:
sealing said cover to said container.

17. The method for mitigating mercury vapor emissions during transportation of mercury containing universal waste between locations according to claim 15, said method comprising the further steps of:
inserting the mercury containing universal waste into a non-porous liner accommodated within said container; and
sealing said liner with said mercury containing universal waste therewithin prior to closing the opening in said container.

18. The method for mitigating mercury vapor emissions during transportation of mercury containing universal waste between locations according to claim 15, wherein said activated carbon media is enclosed within a porous envelope for adsorbing mercury vapors escaping from said mercury containing universal waste.

19. The method of mitigating mercury vapor emissions during transportation of mercury containing universal waste between locations according to claim 15, wherein said container is a disposable box fabricated from relatively rigid cardboard materials.
